(19) United States
(12) Patent Application Publication
(10) Pub. No.: US 2015/0072244 A1
(43) Pub. Date: Mar. 12, 2015

(54) GEL POLYMER LITHIUM ION BATTERY

(71) Applicant: Dongguan Amperex Technology Limited, Dongguan (CN)

(72) Inventors: Hui CHEN, Dongguan (CN); Laiyong XIE, Dongguan (CN); Hui JIANG, Dongguan (CN); Yaoming DENG, Dongguan (CN); Xinzhi ZHANG, Dongguan (CN)

(21) Appl. No.: 14/450,469

(22) Filed: Aug. 4, 2014

(30) Foreign Application Priority Data
Sep. 10, 2013 (CN) 201310410896.6

(51) Int. Cl. H01M 10/0565; H01M 4/62; H01M 4/133; H01M 10/0525

(52) U.S. Cl. CPC H01M 10/0565; H01M 10/0525; H01M 4/622; H01M 4/133; H01M 2300/0082; H01M 2300/0085; H01M 2004/027
USPC 429/303

(57) ABSTRACT

The present invention belongs to the technical field of lithium ion batteries and in particular relates to a gel polymer lithium ion battery comprising a gel polymer electrolyte, a cathode, an anode and a separator spaced between the cathode and the anode, wherein the gel polymer electrolyte includes lithium salt, a non-aqueous solvent and a polymer monomer which includes at least one epoxy monomer containing an epoxy group and a double bond and at least one acrylate monomer, and an anode binder includes a polymer having an amino group or imino group on the main chain or a branched chain thereof.

### FIELD OF THE INVENTION

The present invention belongs to the technical field of lithium ion batteries and in particular relates to a gel polymer lithium ion battery.

### BACKGROUND OF THE INVENTION

The electrolyte of the lithium ion batteries currently sold on the market generally includes a non-aqueous solvent, lithium salt and an additive, as the non-aqueous solvent is liquid, the liquid electrolyte is likely to leak from a battery when the battery is impacted from outside or when the inside of the battery swells, moreover, as an organic solvent is inherently inflammable, a lithium ion battery using a liquid electrolyte has a potential safety hazard such as a potential explosion hazard.

On the contrary, a gel polymer electrolyte is jellylike, containing no freely flowing liquid, thus, a lithium ion battery using a gel polymer electrolyte is free of a liquid leakage problem and is therefore relatively high safe. As the liquid electrolyte solution of a gel polymer electrolyte is trapped in a polymer substrate, the gel polymer electrolyte, like a liquid electrolyte, has a relatively high ion conduction performance to meet the demand of a lithium ion battery on conductivity.

In recent years, a great amount of research has been made on gel polymer lithium ion batteries, for example, different gel polymer batteries or gel polymer electrolytes are disclosed in Chinese Patent Applications No. 03147819.0, No. 01117958.9, No. 01816279.7, No. 03120182.2, No. 200980131065.7 and No. 201180019904.3, a method for preparing the gel polymer electrolytes disclosed in these Patent Applications mainly includes adding a liquid electrolyte and a polymer monomer in a battery or container, adding an initiator into the battery or container to polymerize the polymer monomers with light or heat or through the irradiation of ultraviolet rays or electronic rays to realize gelation.

However, these patents have the following problems: as the surface energy of graphite serving as an anode active material is low and more than 90% of the gel polymer electrolyte is an organic solvent, the binding force between the gel polymer electrolyte and an anode is small. During a cycle process, as an anode active material, such as graphite, is continuously subjected to a lithium intercalation processing and a lithium deintercalation processing, the anode and the gel polymer electrolyte both swell based on different swelling coefficients, leading to the continuous deterioration of an electrolyte/graphite interface, resulting in an increase in the impedance of the battery and a reduction in the cycle performance of the battery, moreover, the poor binding force between the gel polymer electrolyte and the anode also deforms a big and thin battery easily, which degrades the safety of the battery.

### SUMMARY OF THE INVENTION

The present invention aims to address the disadvantages of the prior art with a gel polymer lithium ion battery which avoids the problem that an interface is degraded due to the difference in swelling coefficients of a gel polymer electrolyte and graphite by closely connecting the gel polymer electrolyte with an anode through a cross-linked network formed through the reaction between the epoxy group in the gel polymer electrolyte and the amino in an anode binder and is therefore improved in mechanical strength and deformation resistance, reduced in interface impedance and upgraded in cycle performance and dynamical performance.

To achieve the purpose above, the present invention adopts the following technical scheme:

a gel polymer lithium ion battery comprises a gel polymer electrolyte, a cathode, an anode and a separator spaced between the cathode and the anode, wherein the gel polymer electrolyte includes lithium salt, a non-aqueous solvent and a polymer monomer, the anode includes an anode current collector and an anode film which is arranged on the surface of the anode current collector and includes an anode active material, an anode binder and an anode conductive agent, the polymer monomer includes at least one epoxy monomer containing an epoxy group and a double bond and at least one acrylate monomer, and the anode binder includes a polymer having an amino group or imino group on the main chain or a branched chain thereof.

In the gel polymer lithium ion battery, the non-aqueous solvent may be a well-known solvent such as dimethyl carbonate, diethyl carbonate, ethyl methyl carbonate, γ-butyrolactone, propylene carbonate or ethylene carbonate, and the lithium salt may be a well-known lithium salt such as lithium hexafluorophosphate or lithium tetrafluoroborate. The concentration of the lithium salt is 0.8-1.2M with respect to the non-aqueous solvent. The anode active material is a well-known anode active material such as natural graphite, synthetic graphite, a silicon alloy or a tin alloy.

In the gel polymer lithium ion battery, the epoxy group can be cross-linked with the amino group or imino group to form a stable and firm interface between the gel polymer electrolyte and the anode, moreover, the structure resulting from the cross-linking reaction has a great mechanical property for inhibiting the swelling of the battery, the double bond in the epoxy monomer is copolymerized with that in the acrylate, and the epoxy monomer may be polymerized with the acrylate, thereby forming a gel.

As an improvement of the gel polymer lithium ion battery disclosed herein, the epoxy monomer containing an epoxy group and a double bond is glycidyl methacrylate, 1,2-epoxy-5-hexene, 3,4-epoxy-1-butene, isoprene monoxide or allyl glycidyl ether.

As an improvement of the gel polymer lithium ion battery disclosed herein, the epoxy monomer containing an epoxy group and a double bond accounts for 0.2-0.8% by weight of the gel polymer electrolyte. If the epoxy monomer containing an epoxy group and a double bond accounts for less than 0.2% by weight of the gel polymer electrolyte, then the interface binding force of the polymer gel electrolyte/the anode is not enough for inhibiting the swelling of the battery during a cycle process, however, if the epoxy monomer containing an epoxy group and a double bond accounts for more than 0.8% by weight of the gel polymer electrolyte, then more acrylate monomer is needed to form a gel, resulting in a relatively large monomer amount which will influence the capacity of the battery.

As an improvement of the gel polymer lithium ion battery disclosed herein, the acrylate monomer is cyclohexyl acrylate, vinyl alcohol diacrylate, diallyl carbonate, trimethylolpropane triacrylate, methyl acrylate, ethyl acrylate, butyl acrylate, hexyl acrylate, methyl methacrylate, polyoxyethylene diacrylate or pentaerythritol tetraacrylate.

As an improvement of the gel polymer lithium ion battery disclosed herein, the acrylate monomer accounts for 1.2-3.5% by weight of the gel polymer electrolyte. It is difficult to form a gel if there is little acrylate monomer (less than 1.2%) while the capacity of the battery is influenced if there is much crylate monomer (greater than 3.5%).

As an improvement of the gel polymer lithium ion battery disclosed herein, the polymer having an amino group or imino group on the main chain or a branched chain thereof is polyacrylamide, polybisacrylamide, the copolymer of poly(amide-imide) or the copolymer of poly(acrylamide-styrene-acrylate).

As an improvement of the gel polymer lithium ion battery disclosed herein, the polymer having an amino group or imino group on the main chain or a branched chain thereof accounts for 1.5-3% by weight of the anode film. Film-removal occurs easily if there is little binder while the rate and the high or low temperature performance of the battery is influenced if there is much binder. The anode conductive agent accounts for 1-5% by weight of the anode film.

As an improvement of the gel polymer lithium ion battery disclosed herein, the molar weight of the amino group and the imino group in the anode binder is higher than that of the epoxy group in the epoxy monomer so that there is no unreacted epoxy group in a battery system to avoid the influence caused by residual epoxy groups on the performance of the battery.

As an improvement of the gel polymer lithium ion battery disclosed herein, a method for preparing the gel polymer lithium ion battery comprises: adding a non-aqueous solvent, lithium salt, at least one epoxy monomer containing an epoxy group and a double bond, at least one acrylate monomer and an initiator into the battery case of a battery comprising a cathode, an anode and a separator, placing the battery case containing the aforementioned materials still for 0.5-10 h at 20-49 degrees centigrade so that the epoxy group can react with the amino group or imino group in the anode, baking the battery for 1-10 h at 50-90 degrees centigrade so that the epoxy monomer containing an epoxy group and a double bond is copolymerized with the acrylate monomer, and implementing a formation processing, a shaping processing and a degassing processing to obtain the gel polymer lithium ion battery.

Preferably, before added with the aforementioned materials, the battery is baked so as to remove as much residual moisture in the battery as possible.

As a cross-linking reaction can occur between an epoxy group and an amino group (or imino group) at normal temperature (to accelerate the reaction, the battery may be heated slightly as long as the internal temperature of the battery is lower than 49 degrees centigrade) to form a physical structure having a relatively high mechanical strength to form a stable interface having a strong binding force between the surface of the anode graphite and the gel polymer electrolyte, thus, the internal temperature of the battery should be controlled before the monomers are polymerized as the reaction of the epoxy group with the amino group or imino group will be influenced by the free radical polymerization of the epoxy group which occurs when the initiator functions at a high temperature.

Then, the internal temperature of the battery is heated to 70 degrees centigrade so that the double bonds of the epoxy monomer and the acrylate monomer are copolymerized (certainly, the epoxy monomer and the acrylate monomer may be copolymerized with each other) to form a gel. The temperature range for the copolymerization reaction is 50-90 degrees centigrade, if the temperature is too low, then the initiator decomposes too slowly, resulting in a long reaction time, and if the temperature is too high, the gel polymer electrolyte decomposes and the separator deforms, which degrades the performance of the battery.

As an improvement of the gel polymer lithium ion battery disclosed herein, the initiator accounts for 0.01-0.6% by weight of the gel polymer electrolyte. If the initiator is little, then much monomer (liquid) is left after the gel is formed, resulting in an unsatisfied mechanical performance of the battery, on the other hand, if the initiator is too much, the cost is increased, and a certain influence is caused to the electric performance of the battery, for example, the capacity of the battery is lowered.

As an improvement of the gel polymer lithium ion battery disclosed herein, the initiator is at least one of azodiisobutyronitrile (AIBN), 2,2′-azobis-(2,4-dimethylvaleronitrile), 2,2′-azobis-(2-methylbutyronitrile), 1,1′-azobis(cyclohexanecarbonitrile), benzoylperoxide (BPO), hydrogen peroxide, dodecamoyl peroxide, isobutyryl peroxide, cumene hydroperoxide, tert-butyl peroxypivalate and diisopropyl peroxydicarbonate, each of which can generate free radicals to initiate a copolymerization reaction.

With respect to the prior art, the present invention avoids the problem that a gel polymer electrolyte/anode interface is degraded due to the difference in swelling coefficients of the gel polymer electrolyte and graphite by closely connecting the gel polymer electrolyte with the anode through a cross-linked network formed through the reaction between the epoxy group in an epoxy compound monomer and the amino group or imino group in an anode binder of a polymer containing an amino group or imino group and is therefore improved in mechanical strength and deformation resistance, reduced in interface impedance and upgraded in cycle performance and dynamical performance, moreover, owing to the excellent gel polymer electrolyte/anode interface, the interface impedance of the battery is greatly reduced while the cycle performance and the dynamical performance of the battery are improved.

### DETAILED DESCRIPTION OF THE PREFERRED EMBODIMENTS

The present invention and the beneficial effects thereof are described below in detail with reference to specific embodiments which are not to be construed as limiting the present invention.

### Embodiment 1

The gel polymer lithium ion battery provided in the embodiment comprises a gel polymer electrolyte, a cathode, an anode and a separator spaced between the cathode and the anode, wherein the gel polymer electrolyte includes lithium salt, a non-aqueous solvent and a polymer monomer, the anode includes an anode current collector and an anode film which is arranged on the surface of the anode current collector and includes an anode active material of graphite, an anode binder and an anode conductive agent, the polymer monomer is glycidyl methacrylate and cyclohexyl acrylate which account for 0.6% and 2% by weight of the gel polymer electrolyte, respectively, and the anode binder is polyacrylamide which accounts for 2% by weight of the anode film.

A method for preparing the gel polymer lithium ion battery provided in the embodiment comprises:

adding a non-aqueous solvent, lithium salt, glycidyl methacrylate, cyclohexyl acrylate and an initiator azodiisobutyronitrile (AIBN) into the battery case of a battery comprising a cathode, an anode and a separator, wherein glycidyl methacrylate, cyclohexyl acrylate and the initiator azodiisobutyronitrile account for 0.6%, 2% and 0.1% by weight of the gel polymer electrolyte, respectively, placing the battery case containing the aforementioned materials still for 2 h at 25 degrees centigrade so that the epoxy group in glycidyl methacrylate can react with the amino group in polyacrylamide, baking the battery for 8 h at 60 degrees centigrade so that the double bond in glycidyl methacrylate is copolymerized with the double bond in cyclohexyl acrylate, and implementing a formation processing, a shaping processing and a degassing processing to obtain the gel polymer lithium ion battery.

### Embodiment 2

The difference of embodiment 2 from embodiment 1 lies in that the polymer monomer is 1,2-epoxy-5-hexene and vinyl alcohol diacrylate which account for 0.4% and 3% by weight of the gel polymer electrolyte, respectively, and the anode binder is polybisacrylamide which accounts for 2.5% by weight of the anode film.

A method for preparing the gel polymer lithium ion battery provided in the embodiment comprises:

adding a non-aqueous solvent, lithium salt, 1,2-epoxy-5-hexene, vinyl alcohol diacrylate and an initiator 2,2′-azobis-(2,4-dimethylvaleronitrile) into the battery case of a battery comprising a cathode, an anode and a separator, wherein 1,2-epoxy-5-hexene, vinyl alcohol diacrylate and the initiator 2,2′-azobis-(2,4-dimethylvaleronitrile) account for 0.4%, 3% and 0.5% by weight of the gel polymer electrolyte, placing the battery case containing the aforementioned materials still for 5 h at 30 degrees centigrade so that the epoxy group in 1,2-epoxy-5-hexene can react with the amino group in polybisacrylamide, baking the battery for 5 h at 70 degrees centigrade so that the double bond in 1,2-epoxy-5-hexene is copolymerized with the double bond in vinyl alcohol diacrylate, and implementing a formation processing, a shaping processing and a degassing processing to obtain the gel polymer lithium ion battery.

The other content of embodiment 2 is the same as that of embodiment 1 and is therefore not described repeatedly here.

### Embodiment 3

The difference of embodiment 3 from embodiment 1 lies in that the polymer monomer is 3,4-epoxy-1-butene and diallycarbonate which account for 0.2% and 1.2% by weight of the gel polymer electrolyte, respectively, and the anode binder is the copolymer of poly(amide-imide) which accounts for 1.5% by weight of the anode film.

A method for preparing the gel polymer lithium ion battery provided in the embodiment comprises:

adding a non-aqueous solvent, lithium salt, 3,4-epoxy-1-butene, diallycarbonate and an initiator 2,2′-azobis-(2-methylbutyronitrile) into the battery case of a battery comprising a cathode, an anode and a separator, wherein 3,4-epoxy-1-butene, diallycarbonate and the initiator 2,2′-azobis-(2-methylbutyronitrile) account for 0.2%, 1.2% and 0.01% by weight of the gel polymer electrolyte, respectively, placing the battery case containing the aforementioned materials still for 10 h at 20 degrees centigrade so that the epoxy group in 3,4-epoxy-1-butene can react with the amino group and the imino group in the copolymer of poly(amide-imide), baking the battery for 10 h at 50 degrees centigrade so that the double bond in 3,4-epoxy-1-butene is copolymerized with the double bond in diallycarbonate, and implementing a formation processing, a shaping processing and a degassing processing to obtain the gel polymer lithium ion battery.

The other content of embodiment 3 is the same as that of embodiment 1 and is therefore not described repeatedly here.

### Embodiment 4

The difference of embodiment 4 from embodiment 1 lies in that the polymer monomer is isoprene monoxide and trimethylolpropane triacrylate which account for 0.8% and 3.5% by weight of the gel polymer electrolyte, respectively, and the anode binder is the copolymer of poly(acrylamide-styrene-acrylate) which accounts for 3% by weight of the anode film.

A method for preparing the gel polymer lithium ion battery provided in the embodiment comprises:

adding a non-aqueous solvent, lithium salt, isoprene monoxide, trimethylolpropane triacrylate and an initiator 1,1′-azobis(cyclohexanecarbonitrile) into the battery case of a battery comprising a cathode, an anode and a separator, wherein isoprene monoxide, trimethylolpropane triacrylate and the initiator 1,1′-azobis(cyclohexanecarbonitrile) account for 0.8%, 3.5% and 0.6% by weight of the gel polymer electrolyte, respectively, placing the battery case containing the aforementioned materials still for 0.5 h at 49 degrees centigrade so that the epoxy group in isoprene monoxide can react with the amino group in the copolymer of poly(acrylamide-styrene-acrylate), baking the battery for 1 h at 90 degrees centigrade so that the double bond in isoprene monoxide is copolymerized with the double bond in trimethylolpropane triacrylate, and implementing a formation processing, a shaping processing and a degassing processing to obtain the gel polymer lithium ion battery.

The other content of embodiment 4 is the same as that of embodiment 1 and is therefore not described repeatedly here.

### Embodiment 5

The difference of embodiment 5 from embodiment 1 lies in that the polymer monomer is allyl glycidyl ether and methyl acrylate which account for 0.3% and 1.5% by weight of the gel polymer electrolyte, respectively, and the anode binder is the mixture of polyacrylamide and polybisacrylamide which accounts for 1% by weight of the anode film.

A method for preparing the gel polymer lithium ion battery provided in the embodiment comprises:

adding a non-aqueous solvent, lithium salt, allyl glycidyl ether, methyl acrylate and an initiator benzoyl peroxide (BPO) into the battery case of a battery comprising a cathode, an anode and a separator, wherein allyl glycidyl ether, methyl acrylate and the initiator benzoyl peroxide account for 0.3%, 1.5% and 0.2% by weight of the gel polymer electrolyte, placing the battery case containing the aforementioned materials still for 2 h at 40 degrees centigrade so that the epoxy group in allyl glycidyl ether can react with the amino groups in polyacrylamide and polybisacrylamide, baking the battery for 3 h at 70 degrees centigrade so that the double bond in allyl glycidyl ether is copolymerized with the double bond in methyl acrylate, and implementing a formation processing, a shaping processing and a degassing processing to obtain the gel polymer lithium ion battery.

The other content of embodiment 5 is the same as that of embodiment 1 and is therefore not described repeatedly here.

### Embodiment 6

The difference of embodiment 6 from embodiment 1 lies in that the polymer monomer is 1,2-epoxy-5-hexene, 3,4-epoxy-1-butene and methyl acrylate which account for 0.3%, 0.4% and 2.5% by weight of the gel polymer electrolyte, respectively, the anode binder is polyacrylamide which accounts for 2.5% by weight of the anode film.

A method for preparing the gel polymer lithium ion battery provided in the embodiment comprises:

adding a non-aqueous solvent, lithium salt, 1,2-epoxy-5-hexene, 3,4-epoxy-1-butene, methyl acrylate and an initiator isobutyryl peroxide into the battery case of a battery comprising a cathode, an anode and a separator, wherein 1,2-epoxy-5-hexene, 3,4-epoxy-1-butene, methyl acrylate and the initiator isobutyryl peroxide account for 0.3%, 0.4%, 2.5% and 0.4% by weight of the gel polymer electrolyte, respectively, placing the battery case containing the aforementioned materials still for 6 h at 45 degrees centigrade so that the epoxy groups in 1,2-epoxy-5-hexene and the 3,4-epoxy-1-butene can react with the amino group in polyacrylamide, baking the battery for 6 h at 60 degrees centigrade so that the double bonds in 1,2-epoxy-5-hexene and 3,4-epoxy-1-butene are copolymerized with the double bond in methyl acrylate, and implementing a formation processing, a shaping processing and a degassing processing to obtain the gel polymer lithium ion battery.

The other content of embodiment 6 is the same as that of embodiment 1 and is therefore not described repeatedly here.

### Embodiment 7

The difference of embodiment 7 from embodiment 1 lies in that the polymer monomer is 3,4-epoxy-1-butene, methyl methacrylate and polyoxyethylene diacrylate which account for 0.7%, 1% and 1.8% by weight of the gel polymer electrolyte, respectively, and the anode binder is the copolymer of poly(amide-imide) which accounts for 2.2% by weight of the anode film.

A method for preparing the gel polymer lithium ion battery provided in the embodiment comprises:

adding a non-aqueous solvent, lithium salt, 3,4-epoxy-1-butene, methyl methacrylate, polyoxyethylene diacrylate and an initiator cumene hydroperoxide into the battery case of a battery comprising a cathode, an anode and a separator, wherein 3,4-epoxy-1-butene, methyl methacrylate, polyoxyethylene diacrylate and the initiator cumene hydroperoxide account for 0.7%, 1%, 1.8% and 0.5% by weight of the gel polymer electrolyte, respectively, placing the battery case containing the aforementioned materials still for 4 h at 35 degrees centigrade so that the epoxy group in 3,4-epoxy-1-butene can react with the amino group and the imino group in the copolymer of poly(amide-imide), baking the battery for 4 h at 75 degrees centigrade so that the double bond in 3,4-epoxy-1-butene is copolymerized with the double bonds in methyl methacrylate and polyoxyethylene diacrylate, and implementing a formation processing, a shaping processing and a degassing processing to obtain the gel polymer lithium ion battery.

The other content of embodiment 7 is the same as that of embodiment 1 and is therefore not described repeatedly here.

### Embodiment 8

The difference of embodiment 8 from embodiment 1 lies in that the polymer monomer is 1,2-epoxy-5-hexene and pentaerythritol tetraacrylate which account for 0.25% and 1.7% by weight of the gel polymer electrolyte the anode binder is polybisacrylamide which accounts for 1.8% by weight of the anode film.

A method for preparing the gel polymer lithium ion battery provided in the embodiment comprises:

adding a non-aqueous solvent, lithium salt, 1,2-epoxy-5-hexene, pentaerythritol tetraacrylate and initiators tert-butyl peroxypivalate and diisopropyl peroxydicarbonate into the battery case of a battery comprising a cathode, an anode and a separator, wherein 1,2-epoxy-5-hexene, pentaerythritol tetraacrylate and the initiators tert-butyl peroxypivalate and diisopropyl peroxydicarbonate account for 0.25%, 1.7%. 0.1% and 0.1% by weight of the gel polymer electrolyte, respectively, placing the battery case containing the aforementioned materials still for 1 h at 23 degrees centigrade so that the epoxy group in 1,2-epoxy-5-hexene can react with the amino group in polybisacrylamide, baking the battery for 3 h at 65 degrees centigrade so that the double bond in 1,2-epoxy-5-hexene is copolymerized with the double bond in pentaerythritol tetraacrylate, and implementing a formation processing, a shaping processing and a degassing processing to obtain the gel polymer lithium ion battery.

The other content of embodiment 8 is the same as that of embodiment 1 and is therefore not described repeatedly here.

### Comparative Example 1

Comparative example 1 is merely different from embodiment 1 in that the anode binder is butadiene styrene rubber and the polymer monomer is glycidyl methacrylate and trimethylolpropane triacrylate, and the other content of comparative example 1 is the same as that of embodiment 1 and is therefore not described repeatedly here.

A cycle performance test is conducted for the gel polymer lithium ion batteries provided in embodiments 1 to 8 and comparative example 1 in the following way: record the thicknesses of the batteries as T0, place the batteries still for 5 min, charge the batteries with a constant current rate of 0.5C until the voltage is 4.2V, continue to charge the batteries with a constant voltage until the charge rate is reduced to 0.05C, place the batteries still for 5 min, discharge the batteries at a constant current rate of 0.5C until the voltage is 3.0V to obtain an initial discharge capacity D0(mAh), place the batteries still 3 min, charge the batteries with a constant current rate of 0.5C until the voltage is 4.2V, place the batteries still for 3 min, discharge the batteries at a rate of 0.7C until the voltage is 3.0V, repeat this process for 200 times to obtain a final discharge capacity D200(mAh), meanwhile, record the thicknesses T200 of the batteries and calculate the rate of the volume change of the batteries after 200 times of cycle according to the following formula: (T200-T0)/T0, the result is shown in the following Table 1.

TABLE 1
Result of performance test on batteries provided in
embodiments 1 to 8 and comparative example 1

| | | | Thickness of | | |
|---|---|---|---|---|---|
| | | | fully charged battery | | |
| | | | T (mm) | | |
| | D0 (mAh) | D200 (mAh) | T0 | T200 | Change rate |
| Comparative | 1600 | 1450 | 3.8 | 4.01 | 5.53% |
| example 1 | | | | | |
| Embodiment 1 | 1601 | 1510 | 3.58 | 3.64 | 1.68% |
| Embodiment 2 | 1600 | 1502 | 3.57 | 3.62 | 1.40% |
| Embodiment 3 | 1608 | 1530 | 3.62 | 3.71 | 2.49% |
| Embodiment 4 | 1601 | 1500 | 3.63 | 3.68 | 1.38% |
| Embodiment 5 | 1605 | 1510 | 3.62 | 3.7 | 2.21% |
| Embodiment 6 | 1606 | 1525 | 3.62 | 3.7 | 2.21% |
| Embodiment 7 | 1607 | 1527 | 3.62 | 3.70 | 2.21% |
| Embodiment 8 | 1602 | 1501 | 3.61 | 3.66 | 1.39% |

It can be seen from Table 1 that compared with comparative example 1, the gel polymer lithium ion battery disclosed herein is lower in both discharge capacity and thickness swelling rate after 200 times of cycle, which means that the gel polymer lithium ion battery disclosed herein is better in cycle performance and dynamical performance and is capable of effectively inhibiting battery swelling. The reason lies in that the present invention avoids the problem that an interface is degraded due to the difference in swelling coefficients of a gel electrolyte and graphite by closely connecting the gel polymer electrolyte with an anode through a cross-linked network formed through the reaction between the epoxy group in gel polymer electrolyte and the amino group in an anode binder and is therefore improved in mechanical strength and deformation resistance, moreover, owing to the excellent gel polymer electrolyte/anode interface, the interface impedance of the battery is greatly reduced while the cycle performance and the dynamical performance of the battery are improved.

The battery provided in embodiment 4 has the minimum thickness swelling rate as a large interface binding force inhibits the swelling of the battery in a cycle process to reduce the thickness change of the battery and stabilize the cycle performance of the battery. The battery provided in embodiment 3, although little thicker than the battery provided in embodiment 4, is higher in capacity for a lower monomer concentration.

What is claimed is:

1. A gel polymer lithium ion battery, comprising a gel polymer electrolyte, a cathode, an anode and a separator spaced between the cathode and the anode, wherein:
the gel polymer electrolyte includes lithium salt, a non-aqueous solvent and a polymer monomer;
the anode includes an anode current collector and an anode film which is arranged on the surface of the anode current collector and includes an anode active material, an anode binder and an anode conductive agent;
the polymer monomer includes at least one epoxy monomer containing an epoxy group and a double bond and
at least one acrylate monomer; and
the anode binder includes a polymer having an amino group or imino group on the main chain or a branched chain thereof.

2. The gel polymer lithium ion battery according to claim 1, wherein the epoxy monomer containing an epoxy group and a double bond is glycidyl methacrylate, 1,2-epoxy-5-hexene, 3,4-epoxy-1-butene, isoprene monoxide or allyl glycidyl ether.

3. The gel polymer lithium ion battery according to claim 2, wherein the epoxy monomer containing an epoxy group and a double bond accounts for 0.2-0.8% by weight of the gel polymer electrolyte.

4. The gel polymer lithium ion battery according to claim 1, wherein the acrylate monomer is cyclohexyl acrylate, vinyl alcohol diacrylate, diallyl carbonate, trimethylolpropane triacrylate, methyl acrylate, ethyl acrylate, butyl acrylate, hexyl acrylate, methyl methacrylate, polyoxyethylene diacrylate or pentaerythritol tetraacrylate.

5. The gel polymer lithium ion battery according to claim 4, wherein the acrylate monomer accounts for 1.2-3.5% by weight of the gel polymer electrolyte.

6. The gel polymer lithium ion battery according to claim 4, wherein the polymer having an amino group or imino group on the main chain or a branched chain thereof is polyacrylamide, polybisacrylamide, the copolymer of poly(amide-imide) or the copolymer of poly(acrylamide-styrene-acrylate).

7. The gel polymer lithium ion battery according to claim 6, wherein the polymer having an amino group or imino group on the main chain or a branched chain thereof accounts for 1.5-3% by weight of the anode film.

8. The gel polymer lithium ion battery according to claim 1, wherein the molar weight of the amino group and the imino group in the anode binder is higher than that of the epoxy group in epoxy monomer.

9. The gel polymer lithium ion battery according to claim 1, wherein the gel polymer lithium ion battery is prepared by adding a non-aqueous solvent, lithium salt, at least one epoxy monomer containing an epoxy group and a double bond, at least one acrylate monomer and an initiator into the battery case of a battery comprising a cathode, an anode and a separator, placing the battery case containing the aforementioned materials still for 0.5-10 h at 20-49 degrees centigrade so that the epoxy group can react with the amino group or imino group in the anode, baking the battery for 1-10 h at 50-90 degrees centigrade so that the epoxy monomer containing an epoxy group and a double bond is copolymerized with the acrylate monomer and then implementing a formation processing, a shaping processing and a degassing processing.

10. The gel polymer lithium ion battery according to claim 9, wherein the initiator accounts for 0.01-0.6% by weight of the gel polymer electrolyte.

11. The gel polymer lithium ion battery according to claim 10, wherein the initiator is at least one of azodiisobutyronitrile (AIBN), 2,2′-azobis-(2,4-dimethylvaleronitrile), 2,2′-azobis-(2-methylbutyronitrile), 1,1-azobis(cyclohexane-1-carbonitrile, benzoylperoxide (BPO), hydrogen peroxide, dodecamoyl peroxide, isobutyryl peroxide, cumene hydroperoxide, tert-butyl peroxypivalate and diisopropyl peroxydicarbonate.
